(19) United States
(12) Patent Application Publication
(10) Pub. No.: US 2023/0214782 A1
(43) Pub. Date: Jul. 6, 2023

(54) Intelligent assistant that finds availability, coordinates and decides on meetings between 2 or more entities

(71) Applicant: Tomer Ram, Lehavim, Southern district (IL)

(72) Inventor: Tomer Ram, Lehavim, Southern district (IL)

(21) Appl. No.: 17/567,172

(22) Filed: Jan. 3, 2022

(51) Int. Cl. G06Q 10/10; G06F 40/40; G06F 40/205; H04L 51/046

(52) U.S. Cl. CPC G06Q 10/1093; G06F 40/40; G06F 40/205; H04L 51/046

(57) ABSTRACT

A method of advanced technology allowing to find, coordinate and decide meeting details from larger communications, using neuro linguistic programming to predict and automatically set meeting among multiple individuals. The system utilizes relevant snippets from unstructured data to coordinate the optimal meeting and associated factors. Meeting information is fully edited by natural English, different actions on the calendar invite itself like responding with “No” will activate back end to reschedule with guests. Multiple guests can schedule with Laura and multiple subjects can be in the text which will be understood and parsed by the AI. Once the assistant is added into a messenger platform the assistant will send the users availability to the guest and the guest can answer in natural English or manually press which availability works best for them.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to a meeting organizer apparatus by implementing a natural language processing method. More particularly, the present invention relates to a communication method that understands the meaning behind the sentence and representation of unstructured data to coordinate optimal meeting time between two entities based on multiple indicators.

### Description of the Related Art

Natural language processing (NLP) is a branch of artificial intelligence that helps computers understand, interpret and manipulate human language. NLP draws from many disciplines, including computer science and computational linguistics, in its pursuit to fill the gap between human communication and computer understanding.

While natural language processing isn't a new science, the technology is rapidly advancing thanks to an increased interest in human-to-machine communications, plus an availability of big data, powerful computing and enhanced algorithms.

As a human, one may speak and write in English, Spanish or Chinese. But a computer's native language—known as machine code or machine language—is largely incomprehensible to most people. At your device's lowest levels, communication occurs not with words but through millions of zeros and ones that produce logical actions.

Indeed, programmers used punch cards to communicate with the first computers 70 years ago. This manual and arduous process was understood by a relatively small number of people. Now you can say, “Alexa, I like this song,” and a device playing music in your home will lower the volume and reply, “OK. Rating saved,” in a humanlike voice. Then it adapts its algorithm to play that song—and others like it—the next time you listen to that music station.

Let's take a closer look at that interaction. Your device activated when it heard you speak, understood the unspoken intent in the comment, executed an action and provided feedback in a well-formed English sentence, all in the space of about five seconds. The complete interaction was made possible by NLP, along with other AI elements such as machine learning and deep learning.

From patent prior art research multiple types of innovations have been seen. For instance, a Natural language processing for entity resolution bearing US patent 2,017,0091320A1 is issued to Panjiva Inc. The patent is on an apparatus includes a data. access circuit that interprets data records, each having a number of data fields, a record parsing circuit that determines a number of n-grams from terms of each of the data records and maps the number of n-grams to a corresponding number of mathematical vectors, and a record association circuit that determines whether a similarity value between a first mathematical vector for the first data record and a second mathematical vector for the second data record is greater than a. threshold similarity value, and associates the first and second data records in response to the similarity value exceeding the threshold similarity value. An example apparatus includes a reporting circuit that provides a catalog entity identifier, associates each of the first term and the second term to the catalog entity identifier, and provides a summary of activity for an entity.

Another patent on Methods for generating natural language processing systems bearing US patent 1,012,7214B2 is issued to Aiparc Holdings Pte Ltd. The patent is on methods which are presented for generating a natural language model. The method may comprise: ingesting training data representative of documents to be analyzed by the natural language model, generating a hierarchical data structure comprising at least two topical nodes within which the training data is to be subdivided into by the natural language model, selecting a plurality of documents among the training data to be annotated, generating an annotation prompt for each document configured to elicit an annotation about said document indicating which node among the at least two topical nodes said document is to be classified into, receiving the annotation based on the annotation prompt; and generating the natural language model using an adaptive machine learning process configured to determine patterns among the annotations for how the documents in the training data are to be subdivided according to the at least two topical nodes of the hierarchical data structure.

A Customization natural language processing engine bearing Chinese patent 1,037,82291B is issued to Chinese inventor. The patent discloses a kind of method for customizing natural language processing engine, device and manufacture. Methods described include: One or more parameters of the desired natural language processing task of selection are enabled, the user or untrained user that one or more of parameters are intended to by training use; The parameter of one or more of selections is mapped to the set in one or more intervals of the |input parameter of optimized algorithm and the model for being applied to be used by natural language processing engine by the optimized algorithm of the set in one or more intervals with the |input parameter, to produce customizing model.

Another patent on Methods and systems for using natural language processing and machine-learning to produce vehicle-service content bearing U.S. Pat. No. 9,672,497B1 is issued to Snap On Inc. The patent is on methods and systems for using natural language processing and machine-learning algorithms to process vehicle-service data to generate metadata regarding the vehicle-service data are described herein. A processor can discover vehicle-service data that can be clustered together based on the vehicle-service data having common characteristics. The clustered vehicle-service data can be classified (e.g., categorized) into any one of a plurality of categories. One of the categories can be for clustered vehicle-service data that is tip-worthy (e.g., determined to include data worthy of generating vehicle-service content (e.g., a repair hint). Another category can track instances of vehicle-service data that are considered to be common to an instance of vehicle-service data classified into the tip-worthy category. The vehicle-service data can be collected from repair orders from a plurality of repair shops. The vehicle-service content generated by the systems can be provided to those or other repair shops.

There are multiple solutions that have been presented in prior art. However, these solutions are limited and restricted to their conventional systems. The current invention is focused on presenting a method for designing advance system which takes unstructured data from user to schedule meetings between two or more entities. The intelligent assistant will take unstructured data in the form of words and convert it to structured data that is used to coordinate the optimal meeting time for everyone including but not limited to date, time, location physical and/ or virtual, attendees, who's availability to check one person or several peoples, who's coordinating the meeting, intent of what was said and requested, reasons for why a meeting is moving and/ or canceled and/ or booked.

The current patent discloses a methodology allowing for a tool that automatically provides multiple functionalities. It allows to pull out relevant information from larger communications and analyzes communications to coordinate the best meeting time and type between multiple individuals and if need be will request answers from attendees to ensure a meeting is the correct action.

None of the previous inventions and patents, taken either singly or in combination, is seen to describe the instant invention as claimed. Hence, the inventor of the present invention proposes to resolve and surmount existent technical difficulties to eliminate the aforementioned shortcomings of the prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

The primary desirable object of the present invention is to provide a novel and improved method where the predefined algorithms reads through and understands communication and pull out relevant insights with the goal to find availability, coordination, and finalization of meetings between 2 or more entities.

It is also the objective of the invention to use neuro-linguistic programming (NLP for short) to schedule meetings between two or more entities.

It is also the primary objective of the invention to provide a smart methodology that which operates on texts of any length and will take unstructured data in the form of words and/or numbers and convert it to structured data that is used to coordinate the optimal meeting accordingly with all the variables associated with a meeting such as but not limited to meeting time, location (Physical or Virtual), attendees, length, title, description, cancelations, reschedules, and more.

It is another objective of the invention to provide a system which allows multiple functionalities including changing participants, changing meeting platform type, changing the timeslots they want to request, and if required to cancel a meeting, whether they are relevant to speak to by asking them questions regarding how relevant they are for the host.

It is also the object of the invention to provide an advance system which increases efficiency, speed and reduce the need for manual and outdated procedures.

It is also the object of the invention to provide a system where once the assistant is added into a messenger platform, including but not limited to email, SMS, social media messenger, the assistant will send the users availability to the guest(s)and the guest(s) can answer in natural English or manually press which availability works best for them.

It is further the objective of invention where if any of the meeting details are not available the assistant will request this information from the user/guest.

It is further the objective of the invention to provide an advance system that is simple and convenient to implement and use.

Other aspects, advantages and novel features of the present invention will become apparent from the detailed description of the invention when considered in conjunction with the accompanying claims.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an advanced method for reading and understanding communication and pulling out relevant insights with the goal of finding availability, coordination and decision on meetings between 2 or more entities

The computing device may include software and/or hardware for providing functionality and features described herein. The computing device may therefore include one or more of: logic arrays, memories, analog circuits, digital circuits, software, firmware and processors. The hardware and firmware components of the computing device may include various specialized units, circuits, software and interfaces for providing the functionality and features described herein.

The present invention as per its preferred embodiments shows an environment for meeting request generation, development and management. The environment includes an artificial intelligence neuro-linguistic programming to schedule meetings between two or more entities. The intelligent assistant will take unstructured data in the form of words and convert it to structured data that is used to coordinate the optimal meeting time for everyone including but not limited to date, time, location physical and/ or virtual, attendees, availability status, who's coordinating the meeting, intent of what was said and requested, reasons for why a meeting is moving and/ or cancelled and/ or booked.

The invention as per its further embodiments allows use of time and date parsing along with using subject/intent NLP of what the requests are from the guests the software is able to detect when the guest(s) is/are available and what type of request they have. It further allows to change or update participants, change meeting platform type, changing the timeslots on request, cancelation of meeting, whether they are relevant to speak to by asking them questions regarding how relevant they are for the host. Meeting information is fully edited by natural English, different actions on the calendar invite itself like responding with “No” will activate back end to reschedule with guests. Multiple guests can schedule with Laura by using all of them saying when works best for them to meet. Multiple subjects can be in the text which will be understood and parsed by the Ai.

The invention as per its further embodiments allows use of time and date parsing along with using subject/intent NLP of what the requests are from the guests the software is able to detect when the guest(s) is/are available and what type of request they have, including but not limited to before and after certain events, holidays, or other date and times. It further allows to change or update participants, change meeting platform type, changing the timeslots on request, cancelation of meeting, whether they are relevant to speak to by asking them questions regarding how relevant they are for the host. Meeting information is fully edited by natural English, different actions on the calendar invite itself like responding with “No” will activate back end to reschedule with guests. Multiple guests can schedule with Laura by using all of them saying when works best for them to meet. Multiple subjects can be in the text which will be understood and parsed by the Ai.

NLP breaks up the sentence and sends to the backend the request, then according to a hierarchy for which intent is most important the backend will act upon that to send out the relevant response and book a meeting or ask another question if needed. If any of the meeting details are not available the assistant will request this information from the user/guest.

The assistant as per its additional embodiments is available outside of the platform and is waiting for a signal to start the process of scheduling the meeting. The meeting flow can have the assistant request for more information to understand whether or not this meeting should take place. Furthermore, there is an option to use others' availability only during booking the meeting in case the meeting attendee

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A method for pulling out relevant information and then aggregating and presenting the data to decide a meeting between multiple parties comprising:
obtaining input of unstructured data in the form of words;
performing the operation of converting the received data into structured data; and,
providing output to coordinate the optimal meeting time for every entity which can work on multiple indicators including but not limited to date, time,

II: A novel form of artificial intelligence neuro-linguistic programming aimed to detect guest availability, changing participants, changing meeting platforms, changing timeslots and meeting cancelation features.

III: A specialized NLP platform where meeting information is fully edited by natural language and manual commands where variety of features can be triggered by commands in natural spoken language where:
the system as per claim III, breaks up the sentence and sends to the backend the request;
the system as per claim III, where according to a hierarchy for which intent is most important the backend will act upon that to send out the relevant response; and,
the system as per claim III, where relevant response can include variety of meeting related actions or can ask another question if needed.
A method of advanced technology allowing to find, coordinate and decide meeting details from larger communications, using neuro linguistic programming to predict and automatically set meeting among multiple individuals. The system utilizes relevant snippets from unstructured data to coordinate the optimal meeting and associated factors. Meeting information is fully edited by natural language, different actions on the calendar invite itself like responding with “No” will activate back end to reschedule with guests. Multiple guests can schedule with Laura and multiple subjects can be in the text which will be understood and parsed by the AI. Once the assistant is added into a messenger platform the assistant will send the users availability to the guest and the guest can answer in natural English or manually press which availability works best for them, in addition if requested can ask different business related questions to ensure a meeting is the correct action to take for the end user.
